(19) United States
(12) Patent Application Publication
(10) Pub. No.: US 2004/0130151 A1
(43) Pub. Date: Jul. 8, 2004

(54) Pipe connection and a method for its manufacture

(76) Inventor: Eckart Op Den Camp, Koblenz (DE)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/686,042

(22) Filed: Oct. 15, 2003

(30) Foreign Application Priority Data
Oct. 15, 2002 (DE) 102 48 014.1

(51) Int. Cl. F16L 37/00

(52) U.S. Cl. 285/305

(57) ABSTRACT

A pipe connection, consisting of a pipe (10), a holding plate (14) and a connection piece (18). The pipe is provided with a collar (12) which serves as an abutment for the holding plate, and the connection piece is provided with a groove (18b) into which the holding plate engages.

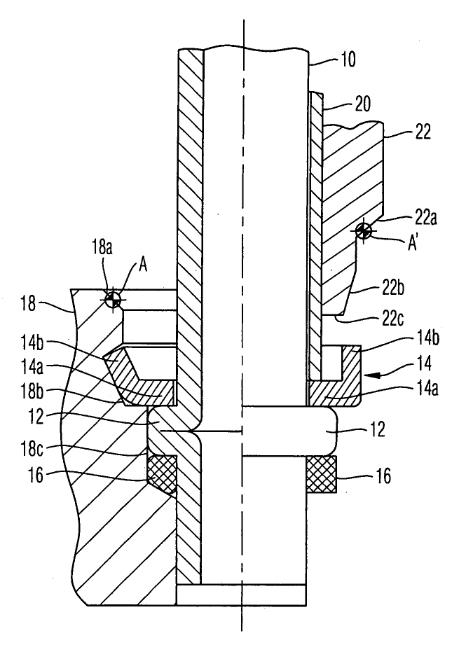

### CROSS REFERENCE TO RELATED APPLICATIONS

This application claims priority to German Patent Application No. 102 48 014.1 filed Oct. 15, 2002.

### BACKGROUND OF THE INVENTION

The invention relates to a pipe connection, in particular for connecting a pipe with a connection of a housing.

Such a pipe connection serves to produce a hydraulic connection between a pipe line and a container or storage vessel. According to the prior art, this is generally achieved by means of a thread connection. Such a thread connection is complicated and liable to error in manufacture and installation. On the one hand, the hydraulic connection must be tightly, sealed, on the other hand, the connection must not be screwed up so tightly that the thread is damaged. The installation generally takes place manually and can not be automated, which leads to increased costs.

### SUMMARY OF THE INVENTION

The object of the invention consists in reducing the number of manual installation steps and lowering the costs.

According to the invention, the pipe connection consists of a pipe, a holding plate and a connection piece, the pipe being provided with a collar which serves as an abutment for the holding plate, and the connection piece being provided with a groove into which the holding plate engages. The parts of which this pipe connection consists, are all very costly to manufacture, and are to be connected in a simple manner so that the pipe connection is tightly sealed.

In addition, the invention generally consists of a method for the manufacture of a pipe connection by means of the following steps:

the holding plate is pushed onto the pipe, so that it lies against the collar;

the pipe is pressed into the connection piece by means of a clamping tool which engages on the holding plate;

a spreading tool is pressed against the holding plate, so that the holding section is widened conically, starting from a ring-shaped initial form, whereby it engages into the groove in the connection piece.

This method is able to be automated in contrast to a conventional method for the production of a connection with a thread, and the connection is not able to be detached after installation.

According to a preferred embodiment of the invention, the clamping tool consists of two parts which, joined together, surround the pipe. Therefore, it is possible in a very simple manner to arrange the clamping tool on the pipe connection and remove it again.

In a further preferred embodiment, the spreading tool consists of two parts which, joined together, surround the clamping tool. Here, also, a particularly simple installation of the spreading tool and a removal again after installation are possible.

It is particularly advantageous if a seal is inserted before the insertion into the connection piece, which seal is compressed by means of the clamping tool before the deformation of the holding ring. The seal makes the pipe connection elastic to a limited extent and also makes possible a good, tightly sealed connection between the pipe and the container in the case of a pipe which has not been manufactured entirely cleanly.

In a further advantageous embodiment, the spreading tool is provided with a contact surface which can lie against a contact surface of the connection piece. Thereby, it is achieved that the spreading tool can assume a precisely defined end position on installation, and the spreading of the holding plate can take place in a precisely defined manner.

If the stroke of the spreading tool relative to the connection piece is monitored, in order to be able to detect the correct deformation of the holding plate, this represents a particularly advantageous and secure way to achieve a tightly sealed installation of the pipe in the connection piece.

Further advantageous embodiments of the invention will be apparent from the sub-claims.

### BRIEF DESCRIPTION OF THE DRAWINGS

The single Figure illustrates a preferred embodiment of a pipe connection shown partially in section, according to the invention, wherein the initial state before the production of the connection being shown on the right, and the final state after completion of the installation being shown on the left.

### DETAILED DESCRIPTION OF THE INVENTION

Firstly, the initial state illustrated to the right of the pipe axis is to be described. A pipe 10 is shown, with a collar 12 which is formed by a bulged region of the pipe. Such a bulged region can be produced in a simple manner without the use of additional structural elements.

At the upper end of the collar 12 with respect to the Figure, a holding plate 14 lies, which consists for example of the favorably priced materials aluminum or galvanized steel. The holding plate has an abutment section 14a and a holding section 14b, the abutment section extending radially to the longitudinal axis of the pipe and the ring-shaped holding section originating from the abutment section. A seal 16 lies against the lower end of the collar with respect to the Figure. The seal material can be any favorably-priced material which is usually used for such seals. A connection piece 18 has an abutment surface 18a, a groove 18b and a mounting 18c. The abutment surface 18a has a first reference point A, the seal 16 lies in the mounting 18c. Lying against the pipe 10 is a clamping tool 20 which engages on the abutment section 14a of the holding plate 14. The clamping tool is surrounded by a spreading tool 22. The spreading tool 22 has a first chamfer 22a on which a second reference point A′ lies. The spreading tool 22 has in addition a second chamber 22b, which is constructed so that at the lower end of the spreading tool an end face 22c is produced. The end face 22c is constructed so that the spreading tool can be introduced into the intermediate space between the clamping tool 20 and the holding section 14b of the holding plate 14.

A preferred method for connecting the pipe and connection piece is described below, the final state after installation being shown in the Figure to the left of the pipe axis. The seal 16 is tightened onto the pipe from below with respect to the Figure and the holding plate 14 is pushed on from above with respect to the Figure. The pipe 10 is pressed into the mounting 18c of the connection piece 18 by means of the clamping tool 20 which lies against the abutment section 14a of the holding plate 14. In so doing, the seal 16 is compressed and thus achieves a secure seal between pipe 10 and connection piece 18. The spreading tool 22 is now pressed against the holding plate 14 so that the holding section 14b is widened conically. Through the forming of the contact surface 18a and the first chamfer 22a of the spreading tool 22, the spreading tool assumes a precisely defined end position with respect to the holding plate and the connection piece. This is achieved when the reference points A and A′ are symmetrical with respect to the pipe axis. In this position, on the one hand it is ensured that the conically widened holding section 14b engages fully into the groove 18b of the connection piece 18, whereby a secure fastening of the pipe 10 in the connection piece is ensured. On the other hand, the spreading tool also can not be pushed beyond the end position, so that damage to the structural elements and hence to the connection itself is avoided.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A pipe connection consisting of a pipe (10), a holding plate (14) and a connection piece (18), the pipe being provided with a collar (12) which serves as an abutment for the holding plate, and the connection piece being provided with a groove (18b) into which the holding plate engages.

2. The pipe connection according to claim 1, characterized in that the connection piece is provided with a mounting (18c) for a seal (16) and the seal engages on the collar (12) on the opposite side from the holding plate (14).

3. The pipe connection according to claim 1 or 2, characterized in that the collar (12) is formed by a bulged region of the pipe (10).

4. The pipe connection according to any of the preceding claims, characterized in that the holding plate (14) has an abutment section (14a) running radially to the longitudinal axis of the pipe (10), which lies against the collar (12), and a conical holding section (14b), which extends starting from the abutment section and engages into the groove (18b).

5. The pipe connection according to any of the preceding claims, characterized in that the connection piece (18) is provided with a contact surface (18a) for a spreading tool (22) which can engage on the holding plate (14).

6. A method for the manufacture of a pipe connection according to any of the preceding claims by means of the following steps:
the holding plate (4) is pushed onto the pipe (10), so that it lies against the collar (12);
the pipe is pressed into the connection piece (18) by means of a clamping tool (20) which engages on the holding plate;
a spreading tool (22) is pressed against the holding plate, so that the holding section (14b) is widened conically started from an annular initial shape, whereby it engages into the groove (18b) in the connection piece.

7. The method according to claim 6, characterized in that the clamping tool (20) consists of two parts which, joined together, surround the pipe (10).

8. The method according to claim 6 or 7, characterized in that the spreading tool (22) consists of two parts which, joined together, surround the clamping tool (20).

9. The method according to any of claims 6 to 8, characterized in that a seal (16) is placed onto the pipe (10) before the insertion into the connection piece (18), which seal (16) is compressed by means of the clamping tool (20) before the deformation of the holding plate (14).

10. The method according to any of claims 6 to 9, characterized in that the spreading tool (22) is provided with an end face (22c) which can lie against a contact surface (18a) of the connection piece (18).

11. The method according to any of claims 6 to 10, characterized in that the stroke of the spreading tool (22) relative to the connection piece (18) is monitored in order to be able to detect the correct deformation of the holding plate (14).
